(19) United States
(12) Patent Application Publication
(10) Pub. No.: US 2021/0301168 A1
(43) Pub. Date: Sep. 30, 2021

(54) FLUID SETS

(71) Applicant: Hewlett-Packard Development Company, L.P., Spring, TX (US)

(72) Inventors: Jie ZHENG, San Diego, CA (US); Dennis Z. GUO, San Diego, CA (US)

(73) Assignee: Hewlett-Packard Development Company, L.P., Spring, TX (US)

(21) Appl. No.: 17/267,173

(22) PCT Filed: Dec. 14, 2018
(86) PCT No.: PCT/US2018/065688

§ 371 Date: Feb. 9, 2021

(51) Int. Cl. C09D 11/54; C09D 11/40; C09D 11/38; C09D 11/322; C09D 11/037; C09D 11/033; C09D 11/107; D06P 5/30; D06P 5/00; B41J 3/407; B41M 5/00

(52) U.S. Cl. CPC C09D 11/54; C09D 11/40; C09D 11/38; C09D 11/322; C09D 11/037; D06P 3/60; C09D 11/107; D06P 5/30; D06P 5/002; B41J 3/4078; B41M 5/0023; C09D 11/033

(57) ABSTRACT

A fluid set can include an ink composition including an ink vehicle, pigment, and from 2 wt % to 15 wt % acrylic latex binder. The fluid set can also include a fixer fluid including a fixer vehicle, and from 0.5 wt % to 12 wt % of a cationic fixing agent including an azetidinium-containing polyamine.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc.

### BRIEF DESCRIPTION OF THE DRAWINGS

FIG. 1 schematically represents an example fluid set, including an ink composition and a fixer fluid, in accordance with the present disclosure;

FIG. 2 schematically depicts an example textile printing system that includes an ink composition, a fixer fluid, and a print media substrate, in accordance with the present disclosure; and

FIG. 3 depicts an example method of printing in accordance with the present disclosure.

### DETAILED DESCRIPTION

Textile printing has various applications and can provide the print media with various natural fabric textures. In accordance with the present disclosure, one example of a fluid set includes an ink composition including an ink vehicle, pigment, and from 2 wt % to 15 wt % acrylic latex binder. The fluid set also includes a fixer fluid including a fixer vehicle and from 0.5 wt % to 12 wt % of a cationic fixing agent with an azetidinium-containing polyamine. In one example, the pigment includes a black pigment, a cyan pigment, a magenta pigment, a yellow pigment, or a white pigment. In another example, the acrylic latex binder is present in the ink composition at from 6 wt % to 11 wt %. In yet another example, the azetidinium-containing polyamine has a ratio of crosslinked or uncrosslinked azetidinium groups to amine groups of from 0.1:1 to 10:1. In an additional example, the fixer fluid is colorless. In still another example, the fixer vehicle includes water and an organic co-solvent, the water being present in the fixer composition in an amount from 65 wt % to 96 wt % and the organic co-solvent being present in the fixer composition in an amount from 1.5 wt % to 34.5 wt %.

In another example, a printing system includes a print media substrate, an ink composition, and a fixer fluid. The ink composition includes an ink vehicle, pigment, and from 2 wt % to 15 wt % acrylic latex binder. The fixer fluid includes a fixer vehicle, and from 0.5 wt % to 12 wt % of a cationic fixing agent comprising an azetidinium- containing polyamine. In one example, the print media substrate is a fabric substrate selected from cotton, polyester, nylon, silk, or a blend thereof. In another example, the azetidinium-containing polyamine includes from 2 to 12 carbon atoms between individual amine groups.

In another example, a method of printing includes jetting a fixer fluid onto a print media substrate and jetting an ink composition onto the print media substrate in contact with the fixer fluid. The fixer fluid includes a fixer vehicle and from 0.5 wt % to 12 wt % of a cationic fixing agent including an azetidinium-containing polyamine. The ink composition includes an ink vehicle, pigment, and from 2 wt % to 15 wt % acrylic latex binder. In one example, jetting the fixer fluid and jetting the ink composition are performed simultaneously. In another example, the cationic fixing agent and the acrylic latex are jetted onto the print media substrate at a weight ratio from 0.05:1 to 1:1. In still other examples, jetting is from a thermal inkjet printhead. In an additional example, the fixer fluid has a surface tension of from 21 dyne/cm to 55 dyne/cm at 25° C. and a viscosity of from 1.5 cP to 15 cP at 25° C. In still additional examples, the method further includes heating the fabric substrate having the fixer fluid and the ink composition jetted thereon to a temperature of from 80° C. to 200° C. for a period of from 5 seconds to 10 minutes.

In addition to the examples described above, the fluid sets, printing systems, and methods of printing will be described in greater detail below. It is also noted that when discussing the fluid sets, printing systems and method of printing described herein, these relative discussions can be considered applicable to the other examples, whether or not they are explicitly discussed in the context of that example. Thus, for example, in discussing a fixer fluid related to a fluid set, such disclosure is also relevant to and directly supported in the context of the printing system and the methods of printing described herein, and vice versa.

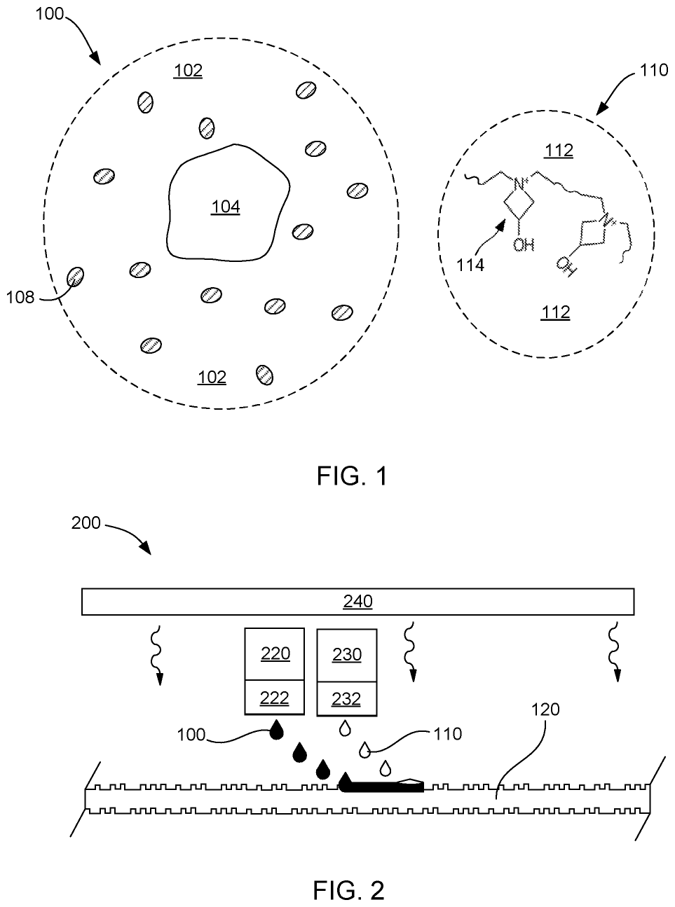

Turning now to FIG. 1, an ink composition 100 can include an ink vehicle 102 (which can include water and organic co-solvent, for example) and pigment 104 (or pigment particles or solids) dispersed therein. An acrylic latex polymer 108 can also be present. In this FIG., the relative sizes of the pigment and the acrylic latex polymer are not necessarily drawn to scale. Furthermore, the pigment can further include a dispersing agent or dispersing polymer associated with a surface thereof, e.g., covalently attached as a part of a self-dispersed pigment, or ionically attracted to adsorbed onto the pigment surface, etc.

The pigment 104 can be any of a number of pigment colorant of any of a number of primary or secondary colors, or can be black or white, for example. More specifically, if a color, the color may include cyan, magenta, yellow, red, blue, violet, orange, green, etc. In one example, the ink composition 100 can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, P048, P049, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., Pigment Yellow 74 and Pigment Yellow 155. In one example, the pigment can include aromatic moieties. In yet another example, the ink composition can be a white ink with a white pigment, e.g. titanium dioxide, talc, zinc oxide, zinc sulfide, lithopone, etc.

With respect to the dispersing agent or dispersing polymer mentioned previously, in some examples, the pigment 104 can be dispersed by a polymer dispersant, such as a styrene (meth)acrylate dispersant, or another dispersant suitable for keeping the pigment suspended in the liquid vehicle 102. For example, the dispersant can be any dispersing (meth)acrylate polymer, or other type of polymer, such as a styrene maleic acid copolymer. In one specific example, the (meth)acrylate polymer can be a styrene-acrylic type dispersant polymer, as it can promote Tr-stacking between the aromatic ring of the dispersant and various types of pigments, such as copper phthalocyanine pigments, for example. Examples of commercially available styrene-acrylic dispersants can include Joncryl® 671, Joncryl® 71, Joncryl® 96, Joncryl® 680, Joncryl® 683, Joncryl® 678, Joncryl® 690, Joncryl® 296, Joncryl 671, Joncryl 696 or Joncryl® ECO 675 (all available from BASF Corp., Germany).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both).

This can be the case for either dispersant polymer for pigment dispersion or for dispersed polymer binder that may include co-polymerized acrylate and/or methacrylate monomers. Also, in some examples, the terms “(meth)acrylate” and “(meth)acrylic acid” can be used interchangeably, as acrylates and methacrylates described herein include salts of acrylic acid and methacrylic acid, respectively. Thus, mention of one compound over another can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt form). Thus, a monomer or a moiety of a polymer described as (meth)acrylic acid or as (meth)acrylate should not be read so rigidly as to not consider relative pH levels, and other general organic chemistry concepts.

In further detail, the ink composition 100 can also include an acrylic latex binder 108. A variety of acrylic latex binders can be employed. In some examples, the acrylic latex binder can include any dispersed polymer prepared from acrylate and/or methacrylate monomers, including an aromatic (meth)acrylate monomer that results in aromatic (meth)acrylate moieties as part of the acrylic latex. In some examples, the acrylic latex particles can include a single heteropolymer that is homogenously copolymerized. In another example, a multi-phase acrylic latex polymer can be prepared that includes a first heteropolymer and a second heteropolymer. The two heteropolymers can be physically separated in the acrylic latex particles, such as in a core-shell configuration, a two-hemisphere configuration, smaller spheres of one phase distributed in a larger sphere of the other phase, interlocking strands of the two phases, and so on. If a two-phase polymer, the first heteropolymer phase can be polymerized from two or more aliphatic (meth)acrylate ester monomers or two or more aliphatic (meth)acrylamide monomers. The second heteropolymer phase can be polymerized from a cycloaliphatic monomer, such as a cycloaliphatic (meth)acrylate monomer or a cycloaliphatic (meth)acrylamide monomer. The first or second heteropolymer phase can include the aromatic (meth)acrylate monomer, e.g., phenyl, benzyl, naphthyl, etc. In one example, the aromatic (meth)acrylate monomer can be a phenoxylalkyl (meth)acrylate that forms a phenoxylalkyl (meth)acrylate moiety within the acrylic latex polymer, e.g. phenoxylether, phenoxylpropyl, etc. The second heteropolymer phase can have a higher T_{g} than the first heteropolymer phase in one example. The first heteropolymer composition may be considered a soft polymer composition and the second heteropolymers composition may be considered a hard polymer composition. If a two-phase heteropolymer, the first heteropolymer composition can be present in the acrylic latex polymer in an amount ranging from 15 wt % to 70 wt % of a total weight of the polymer particle, and the second heteropolymer composition can be present in an amount ranging from 30 wt % to 85 wt % of the total weight of the polymer particle.

In more general terms, whether there is a single heteropolymer phase, or there are multiple heteropolymer phases, heteropolymer(s) or copolymer(s) can include a number of various types of copolymerized monomers, including aliphatic(meth)acrylate ester monomers, such as linear or branched aliphatic (meth)acrylate monomers, cycloaliphatic (meth)acrylate ester monomers, or aromatic monomers. However, in accordance with the present disclosure, the aromatic monomer(s) selected for use can include an aromatic (meth)acrylate monomer.

Examples of aromatic (meth)acrylate monomers that can be used in a heteropolymer or copolymer of the acrylic latex (single-phase, dual-phase in one or both phases, etc.) include 2-phenoxylethyl methacrylate, 2-phenoxylethyl acrylate, phenyl propyl methacrylate, phenyl propyl acrylate, benzyl methacrylate, benzyl acrylate, phenylethyl methacrylate, phenylethyl acrylate, benzhydryl methacrylate, benzhydryl acrylate, 2-hydroxy-3-phenoxypropyl acrylate, 2-hydroxy-3-phenoxypropyl methacrylate, naphthyl methacrylate, naphthyl acrylate, phenyl methacrylate, phenyl acrylate, or a combination thereof. In one example, the acrylic latex polymer can include a phenoxylethyl acrylate and a phenoxylethyl methacrylate, or a combination of a phenoxylethyl acrylate and phenoxylethyl methacrylate.

Examples of the linear aliphatic (meth)acrylate monomers that can be used include ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, hexyl acrylate, hexyl methacrylate, isooctyl acrylate, isooctyl methacrylate, octadecyl acrylate, octadecyl methacrylate, lauryl acrylate, lauryl methacrylate, hydroxyethyl acrylate, hydroxyethyl methacrylate, hydroxyhexyl acrylate, hydroxyhexyl methacrylate, hydroxyoctadecyl acrylate, hydroxyoctadecyl methacrylate, hydroxylauryl methacrylate, hydroxylauryl acrylate, 2-ethylhexyl acrylate, 2-ethylhexyl methacrylate, and combinations thereof.

Examples of the cycloaliphatic (meth)acrylate ester monomers can include cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, and combinations thereof.

In other examples, the acrylic latex binder can include polymerized copolymers, such as emulsion polymers, of one or more monomer, and can also be prepared using a reactive surfactant in some examples. Exemplary reactive surfactants can include polyoxyethylene alkylphenyl ether ammonium sulfate surfactant, alkylphenol ethoxylate free polymerizable anonioc surfactant, sodium polyoxyethylene alkylether sulfuric ester based polymerizable surfactant, or a combination thereof. Commercially available examples include Hitenol® AR series, Hitenol® KH series (e.g. KH-05 or KH-10), or Hitenol® BC series, e.g., Hitenol® BC-10, BC-30, (all available from Montello, Inc., Oklahoma), or combinations thereof. Exemplary monomers that can be used include styrene, alkyl methacrylate (for example C1 to C8 alkyl methacrylate), alkyl methacrylamide (for example C1 to C8 alkyl methacrylamide), butyl acrylate, methacrylic acid, or combinations thereof. In some examples, the acrylic latex particles can be prepared by combining the monomers as an aqueous emulsion with an initiator. The initiator may be selected from a persulfate, such as a metal persulfate or an ammonium persulfate. In some examples, the initiator may be selected from a sodium persulfate, ammonium persulfate or potassium persulfate.

The acrylic latex binder can typically be present in the ink composition in an amount from 2 wt % to 15 wt %. In other examples, the acrylic latex binder can be present in the ink composition in an amount from 6 wt % to 11 wt %. In yet other examples, the acrylic latex binder can be present in the ink composition in an amount from 8 wt % to 12 wt %. In still other examples, the acrylic latex binder can be present in the ink composition in an amount from 5 wt % to 9 wt %.

Returning now to FIG. 1, the ink compositions 100 of the present disclosure can be formulated to include an ink vehicle 102, which can include the water content, e.g., 60 wt % to 90 wt % or from 75 wt % to 85 wt %, as well as organic co-solvent, e.g., from 4 wt % to 30 wt %, from 6 wt % to 20 wt %, or from 8 wt % to 15 wt %. Other liquid vehicle components can also be included, such as surfactant, antibacterial agent, other colorant, etc. However, as part of the ink composition, pigment, polymer dispersant, and the acrylic latex polymer can be included or carried by the ink vehicle components.

In further detail regarding the ink vehicle 102, co-solvent(s) can be present and can include any co-solvent or combination of co-solvents that is compatible with the pigment, dispersant, and polymer acrylic latex. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, e.g., Dowanol™ TPM (from Dow Chemical, USA), higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol,and/or ethoxylated glycerols such as LEG-1, etc.

The ink vehicle can also include surfactant. In general, the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 (from Evonik, Germany), Capstone® surfactant, e.g., Capstone® FS-35 (from Du Pont, USA), or a Tergitol™ surfactant, e.g., Tergitol™ TMN-6 or Tergitol™ 15-S-7 (from Dow Chemical, USA). In another example, the surfactant can include an anionic surfactant, such as a phosphate ester of a C1 0 to C20 alcohol or a polyethylene glycol (3) oleyl mono/di phosphate, e.g., Crodafos® N3A (from Croda International PLC, United Kingdom). The surfactant or combinations of surfactants, if present, can be included in the ink composition at from 0.01 wt % to 5 wt % and, in some examples, can be present at from 0.05 wt % to 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents such as EDTA (ethylene diamine tetra acetic acid) or a trisodium salt of methylglycinediacetic acid (Na3MGDA), e.g. Triloe M (from BASF Corp., Germany) may be included to eliminate the deleterious effects of heavy metal impurities, and buffer solutions may be used to control the pH of the ink. Viscosity modifiers, waxes (e.g. Liquilube™ 405 wax (from Lubrizol Corp., USA)) and buffers may also be present, as well as other additives to modify properties of the ink as desired.

As also shown in FIG. 1, a fixer fluid 110 is also shown, which can include a cationic fixing agent 114 including an azetidinium-containing polyamine in a fixer vehicle 112. Notably, the ink vehicle in the ink composition and the fixer vehicle in the fixer fluid may or may not include the same vehicle formulation, but in one example, they are not the same. Regardless, whether the ink vehicle and the fixer vehicle are the same, they can in some examples include common ingredients, such as water, for example, or other common organic co-solvents. Whether the same or different, both can also include an organic co-solvent. Thus, the discussion of the liquid vehicle described herein related to the ink composition is also relevant to the fixer vehicle of the fixer fluid, and the same types of vehicle components can be independently selected for use therein.

In some specific examples, the fixer vehicle can include from water and an organic co-solvent. Typically, water can be present in the fixer fluid in an amount from 65 wt % to 96 wt %. In other examples, water can be present in the fixer fluid in an amount from 70 wt % to 90 wt %. In still other examples, water can be present in the fixer fluid in an amount from 75 wt % to 85 wt %. Organic co-solvent can typically be present in the fixer fluid in an amount from 1.5 wt % to 34.5 wt %. In some examples, organic co-solvent can be present in the fixer fluid in an amount from 4 wt % to 20 wt %. In another examples, organic co-solvent can be present in the fixer fluid in an amount from 6 wt % to 16 wt %, or from 8 wt % to 14 wt %.

With specific reference to the cationic fixing agent 114 including an azetidinium-containing polyamine that is present in the fixer fluid 110, FIG. 1 presents a representative simplified schematic formula for illustrative purposes only. The cationic fixing agent selected for use can be any of a number of cationic polyamines with a plurality of azetidinium groups. In an uncrosslinked state, as shown in FIG. 1, an azetidinium group generally has a structure as follows:

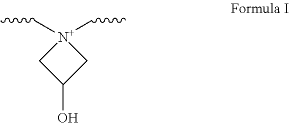

In some examples, the cationic fixing agent including the azetidinium-containing polyamine can be derived from the reaction of a polyalkylene polyamine (e.g. ethylenediamine, bishexamethylenetriamine, and hexamethylenediamine, for example) with an epihalohydrin (e.g. epichlorohydrin, for example) (referred to as PAmE resins).

In some specific examples, the cationic fixing agents including an azetidinium-containing polyamine can include the structure:

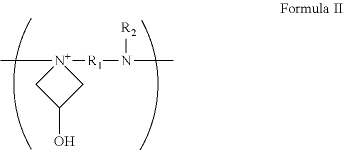

where R₁ can be a substituted or unsubstituted C₂-C₁₂ linear alkyl group and R₂ is H or CH₃. In some additional examples, R₁ can be a C₂-C₁₀, C₂-C₈, or C₂-C₆ linear alkyl group. More generally, there can typically be from 2 to 12 carbon atoms between amine groups (including azetidinium groups) in the azetidinium-containing polyamine. In other examples, there can be from 2 to 10, from 2 to 8, or from 2 to 6 carbon atoms between amine groups in the azetidinium-containing polyamine. In some examples, where R₁ is a C₃-C₁₂ (or C₃-C₁₀, C₃-C₈, C₃-C₆, etc.) linear alkyl group, a carbon atom along the alkyl chain can be a carbonyl carbon, with the proviso that the carbonyl carbon does not form part of an amide group (i.e. R₁ does not include or form part of an amide group). In some additional examples, where R₁ is a C₃-C₁₂ (or C₃-C₁₀, C₃-C₈, C₃-C₆, etc.) linear alkyl group, a carbon atom of R₁ can include a pendent hydroxyl group.

As can be seen in Formula II the cationic fixing agent can include a quaternary amine (e.g. azetidinium group) and a non-quaternary amine (i.e. a primary amine, a secondary amine, a tertiary amine, or a combination thereof). In some specific examples, the cationic fixing agent can include a quaternary amine and a tertiary amine. In some additional examples, the cationic fixing agent can include a quaternary amine and a secondary amine. In some further examples, the cationic fixing agent can include a quaternary amine and a primary amine. It is noted that, in some examples, some of the azetidinium groups of the cationic fixing agent can be crosslinked to a second functional group along the azetidinium-containing polyamine. Whether or not this is the case, the azetidinium-containing polyamine can generally have a ratio of crosslinked or uncrosslinked azetidinium groups to other amine groups of from 0.1:1 to 10:1. In other examples, the azetidinium-containing polyamine can have a ratio of crosslinked or uncrosslinked azetidinium groups to other amine groups of from 0.5:1 to 2:1. Non-limiting examples of commercially available azetidinium-containing polyamines are Crepetrol™ 73, Kymene™ 736, Polycup™ 1884, Polycup™ 7360, and Polycup™ 7360A each available from Solenis LLC (Delaware, USA).

Thus, when the fixer fluid is printed on the print media substrate (not shown in FIG. 1, but shown in FIG. 2), carboxylic acid groups (e.g. the (meth)acrylic acid group(s)) or other suitable reactive groups that may be present at a surface of the acrylic latex binder in the ink composition, and in some instances, hydroxyl groups (e.g.

for cotton), amine groups (e.g. for nylon), thiol groups (e.g. for wool), or other suitable reactive groups that may be present at the surface of the print media substrate, can interact with the azetidinium groups in the fixer fluid to generate a high quality image that exhibits durable washfastness as demonstrated in the examples hereinafter. The cationic fixing agent including an azetidinium-containing polyamine can be present in the fixer fluid at from 0.5 wt % to 12 wt %, from 1 wt % to 7 wt %, from 2 wt % to 6 wt %, from 3 wt % to 5 wt %, or from 3 wt % to 6 wt %, for example.

Non-limiting but illustrative example reactions between the azetidinium group and various reactive groups are illustrated below in Formulas III-1V, as follows:

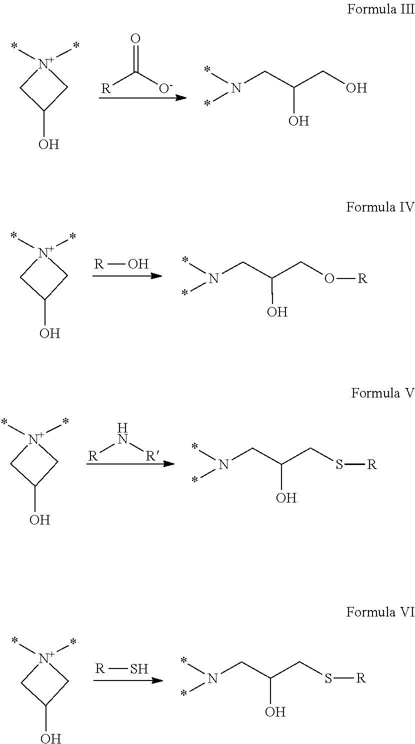

In Formulas III-VI, the asterisks (*) represent portions of the various organic compounds that may not be directly part of the reaction shown in Formulas III-VI, and are thus not shown, but could be any of a number of organic groups or functional moieties, for example. Likewise, R and R′ can be H or any of a number of organic groups, such as those described previously in connection with R₁ or R₂ in Formula II, without limitation.

In further detail, in accordance with examples of the present disclosure, the azetidinium groups present in the fixer fluid can interact with the acrylic latex binder, the print media substrate, or both to form a covalent linkage therewith, as shown in Formulas III-VI above. Other types of reactions can also occur, but Formulas III-VI are provided by way of example to illustrate examples of reactions that can occur when the ink composition, the print media substrate, or both come into contact with the fixer fluid, e.g., interaction or reaction with the substrate, interaction or reaction between different types of acrylic latex polymer, interaction or reaction between different types of azetidinium-containing polyamines, interactions or reactions with different molar ratios (other than 1:1, for example) than that shown in Formulas etc.

As shown in FIG. 2, a textile printing system 200 is shown schematically and can include an ink composition 100 and a fixer fluid 110 for printing on a print media substrate 120. In some examples, the textile printing system can further include various architectures related to ejecting fluids and treated fluids after ejecting onto the print media substrate. For example, the ink composition can be printed from an inkjet pen 220 which includes an ejector 222, such as a thermal inkjet ejector or some other digital ejector technology. Likewise, the fixer fluid can be printed from a fluidjet pen 230 which includes an ejector 232, such as a thermal ejector or some other digital ejector technology. The inkjet pen and the fluidjet pen can be the same type of ejector, or can be two different types ejectors. Both may be thermal inkjet ejectors, for example. Also shown, as can be included in one example, is a heating device 240 to apply heat to the print media substrate to cure the ink composition, e.g., causing the crosslinking reaction to occur or accelerate.

The ink compositions 100 and fixer fluids 110 may be suitable for printing on many types of print media substrates 120, such as paper, textiles, etc. Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the fabric substrates can include polymeric fibers such as, nylon fibers, polyvinyl chloride (PVC) fibers, PVC-free fibers made of polyester, polyamide, polyimide, polyacrylic, polypropylene, polyethylene, acrylic latex, polystyrene, polyaramid (e.g., Kevlar®) polytetrafluoroethylene (Teflon®) (both trademarks of E. I. du Pont de Nemours Company, Delaware), fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, a copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

The fabric substrate can be in one of many different forms, including, for example, a textile, a cloth, a fabric material, fabric clothing, or other fabric product suitable for applying ink, and the fabric substrate can have any of a number of fabric structures. The term “fabric structure” is intended to include structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom.

It is notable that the term “fabric substrate” or “fabric media substrate” does not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into a finished article (e.g. clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of 90°. This woven fabric can include but is not limited to, fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of two or more of these processes.

As previously mentioned, the fabric substrate can be a combination of fiber types, e.g. a combination of any natural fiber with another natural fiber, any natural fiber with a synthetic fiber, a synthetic fiber with another synthetic fiber, or mixtures of multiple types of natural fibers and/or synthetic fibers in any of the above combinations.

In some examples, the fabric substrate can include natural fiber and synthetic fiber. The amount of each fiber type can vary. For example, the amount of the natural fiber can vary from 5 wt % to 95 wt % and the amount of synthetic fiber can range from 5 wt % to 95 wt %. In yet another example, the amount of the natural fiber can vary from 10 wt % to 80 wt % and the synthetic fiber can be present from 20 wt % to 90 wt %. In other examples, the amount of the natural fiber can be 10 wt % to 90 wt % and the amount of synthetic fiber can also be 10 wt % to 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

In one example, the fabric substrate can have a basis weight ranging from 10 gsm to 500 gsm. In another example, the fabric substrate can have a basis weight ranging from 50 gsm to 400 gsm. In other examples, the fabric substrate can have a basis weight ranging from 100 gsm to 300 gsm, from 75 gsm to 250 gsm, from 125 gsm to 300 gsm, or from 150 gsm to 350 gsm.

In addition, the fabric substrate can contain additives including, but not limited to, colorant (e.g., pigments, dyes, and tints), antistatic agents, brightening agents, nucleating agents, antioxidants, UV stabilizers, fillers and lubricants, for example. Alternatively, the fabric substrate may be pre-treated in a solution containing the substances listed above before applying other treatments or coating layers.

Regardless of the substrate, whether paper, natural fabric, synthetic fabric, fabric blend, treated, untreated, etc., the print media substrates printed with the fluid sets of the present disclosure can provide acceptable optical density (OD) and/or washfastness properties. The term “washfastness” can be defined as the OD that is retained or delta E (ΔE) after five (5) standard washing machine cycles using warm water and a standard clothing detergent (e.g., Tide® available from Proctor and Gamble, Cincinnati, OH, USA). Essentially, by measuring OD and/or L*a*b* both before and after washing, ΔOD and ΔE value can be determined, which is essentially a quantitative way of expressing the difference between the OD and/or L*a*b* prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The1976 standard can be referred to herein as “ΔE_{CIE}.” The CIE definition was modified in 1994 to address some perceptual non-uniformities, retaining the L*a*b* color space, but modifying to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (R_{T}) to deal with the problematic blue region at hue angles of)275°), ii) compensation for neutral colors or the primed values in the L*C*h differences, iii) compensation for lightness (S_{L}), iv) compensation for chroma (Sc), and v) compensation for hue (S_{H}). The 2000 modification can be referred to herein as “ΔE2000.” In accordance with examples of the present disclosure, ΔE value can be determined using the CIE definition established in 1976, 1994, and 2000 to demonstrate washfastness. However, in the examples of the present disclosure, ΔE_{CIE} and ΔE₂₀₀₀ are used.

In further detail, the textile printing system 200 can include a fixer fluid 110, which can include a cationic fixing agent including an azetidinium-containing polyamine in a liquid vehicle, as previously mentioned. The fixer fluid can be printed from a fluidjet pen 230 which includes an ejector 232, such as a fluid ejector which can also be a thermal inkjet ejector. As mentioned, in one example, the azetidinium groups of the fixer fluid can interact with the acrylic latex binder (of the ink composition 100), the print media substrate 120, or both to form a covalent linkage therewith. In some examples, a curing device 240 can be used to apply heat to the print media substrate to cure the ink composition, e.g., causing the crosslinking reaction to occur or accelerate.

Heat can be applied using forced hot air, a heating lamp, an oven, or the like. Curing the ink composition contacted with the fixer fluid on the print media substrate can occur at a temperature from 80° C. to 200° C. for from 5 seconds to 10 minutes, or from 130° C. to 180° C. for from 30 seconds to 4 minutes.

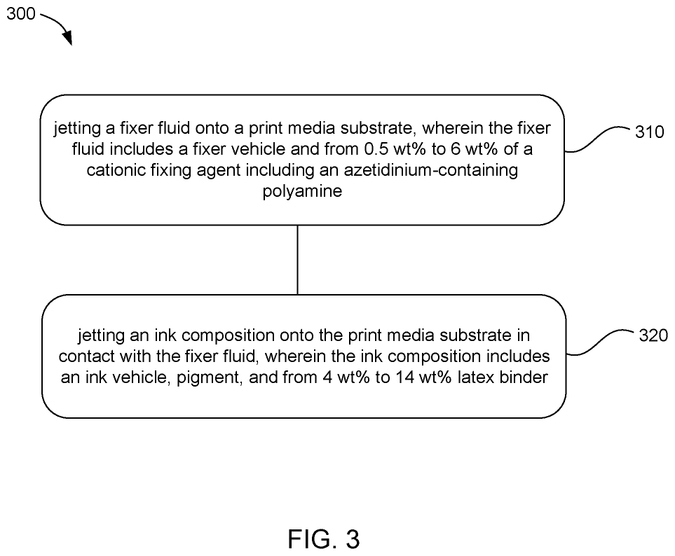

In another example, and as set forth in FIG. 3, a method 300 of printing can include jetting 310 a fixer fluid onto a print media substrate, wherein the fixer fluid includes a fixer vehicle and from 0.5 wt % to 12 wt % of a cationic fixing agent including an azetidinium-containing polyamine. The method can further include jetting 320 an ink composition onto the print media substrate in contact with the fixer fluid, wherein the ink composition includes an ink vehicle, pigment, and from 2 wt % to 15 wt % acrylic latex binder. In some specific examples, jetting the fixer fluid onto the print media substrate and jetting the ink composition onto the print media substrate can be performed simultaneously. In other examples, jetting the fixer fluid onto the print media substrate can be performed prior to jetting the ink composition onto the print media substrate. For example, the fixer fluid can be applied by analog or other digital methods (e.g. piezo, mechanical jetting, etc.) to the print media substrate followed by jetting the ink composition onto the print media substrate. In some examples, the cationic fixing agent and the acrylic latex binder can be jetted onto the print media substrate at a weight ratio of from 0.01:1 to 1:1, or from 0.05:1 to 1:1. In other examples, the cationic fixing agent and the acrylic latex binder can be jetted onto the print media substrate at a weight ratio from 0.2:1 to 0.5:1.

For purposes of good jettability, the fixer fluid can have a surface tension of from 21 dyne/cm to 55 dyne/cm at 25° C. and a viscosity of from 1.5 cP to 15 cP at 25 ° C., which is particularly useful for thermal ejector technology, though surface tensions outside of this range can be used for some types of ejector technology, e.g., piezoelectric ejector technology. Surface tension can be measured by Wilhelmy plate method with Kruss tensiometer.

It is also noted that the method of printing can also include heating the fixer fluid and the ink composition to a temperature of from 80° C. to 200° C. for a period of from 5 seconds to 10 minutes, or other suitable temperature and time-frame as disclosed herein. Suitable heating devices can include heating lamps, curing ovens, forced air drying devices, or the like that apply heated air to the media substrate.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those in the field technology determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following are only exemplary or illustrative of the application of the principles of the presented fabric print media and associated methods. Numerous modifications and alternatives may be devised without departing from the present disclosure. The appended claims are intended to cover such modifications and arrangements. Thus, while the disclosure has been provided with particularity, the following describes further detail in connection with what are presently deemed to be the acceptable examples.

### Example 1

### Preparation of Ink Compositions

Four ink compositions were prepared in accordance with the general formulations shown in Tables 1A, namely a Black (K) Ink, a Cyan (C) Ink, a Magenta (M) Ink, and a Yellow (Y) Ink.

TABLE 1A
Ink Compositions

| | | Black | Cyan | Magenta | Yellow |
|---|---|---|---|---|---|
| | | (K) | (C) | (M) | (Y) |
| | | Ink | Ink | Ink | Ink |
| Ink ID | Category | (Wt %) | (Wt %) | (Wt %) | (Wt %) |
| Black Pigment | Pigment | 2.65 | — | — | — |
| | Dispersion | | | | |
| Cyan Pigment | Pigment | — | 1.68 | — | — |
| | Dispersion | | | | |
| Magenta Pigment | Pigment | — | — | 3.34 | — |
| | Dispersion | | | | |
| Yellow Pigment | Pigment | — | — | — | 3.65 |
| | Dispersion | | | | |
| ¹Acrylic latex | Dispersed | 10 | 10 | 10 | 10 |
| Polymer | polymer | | | | |
| (solids content) | binder | | | | |
| 1,2-butanediol | Organic | 18 | 18 | 18 | 18 |
| | Cosolvent | | | | |
| 2-pyrrolidone | Organic | 3 | 3 | 3 | 3 |
| | Cosolvent | | | | |
| Dowanol ® TPM | Organic | 2 | 2 | 2 | 2 |
| | Cosolvent | | | | |
| Crodafos ® 03A | Surfactant | 0.5 | 0.35 | 0.35 | 0.35 |
| Tergitol ® 15-S-7 | Surfactant | 0.2 | 0.2 | 0.2 | 0.2 |
| Capstone ® FS-35 | Nonionic | 0.4 | 0.4 | 0.4 | 0.4 |
| | Fluoro- | | | | |
| | surfactant | | | | |
| 20 wt % 1,2- | Micro- | 0.2 | 0.2 | 0.2 | 0.2 |
| Benzisothiazolin- | biocide | | | | |
| 3-one | | | | | |
| (Acticide ® B20) | | | | | |
| Deionized Water | Water | Balance | Balance | Balance | Balance |

| | | | | |
|---|---|---|---|---|
| pH adjusted using KOH to: | 8.5 | 8.5 | 8.5 | 8.5 |

¹Two heteropolymer phases: Phase-one included methyl methacrylate, butyl acrylate, and methacrylic acid; Phase-two included cyclohexyl methacrylate, cyclohexyl acrylate, phenoxylethyl methacrylate, and methacrylic acid. Particle size: 0.215 μm (particle size determined using Microtrac Nanotrac Wave II).
Dowanol ® is a tripropylene glycol methyl ether available from Dow Chemical (USA).
Crodafos ™ is available from Croda ® International Plc. (Great Britain).
Tergitol ® is available from Dow Chemical (USA).
Capstone ® is available from Du Pont (USA).
Acticide ® is available from Thor Specialties, Inc. (USA).

Two additional ink compositions were prepared with a different binder in accordance with the general formulations shown in Tables 1B, namely a Black (K) Ink and a Magenta (M) Ink.

TABLE 1B
Ink Compositions

| | | Black | Cyan | Magenta | Yellow |
|---|---|---|---|---|---|
| | | (K) | (C) | (M) | (Y) |
| | | Ink | Ink | Ink | Ink |
| Ingredient | Type | (Wt %) | (Wt %) | (Wt %) | (Wt %) |
| Black Pigment | Pigment | 1.96 | — | — | — |
| | Dispersion | | | | |
| Cyan Pigment | Pigment | — | 1.5 | — | — |
| | Dispersion | | | | |
| Magenta Pigment | Pigment | — | — | 2.99 | — |
| | Dispersion | | | | |
| Yellow Pigment | Pigment | — | — | — | 2.85 |
| | Dispersion | | | | |
| 2-pyrrolidinone (2P) | Organic | 13 | 13 | 13 | 13 |
| | Cosolvent | | | | |
| 2-methyl-1,3- | Organic | 9 | 9 | 9 | 9 |
| propanediol (MPDiol) | Cosolvent | | | | |
| Oleth-3 phosphate | Anionic | 0.2 | 0.2 | 0.2 | 0.2 |
| (Crodafos ™ N-3 Acid) | Surfactant | | | | |
| Tergitol ® 15-S-7 | Non-ionic | 0.5 | 0.5 | 0.5 | 0.5 |
| | surfactant | | | | |
| Tergitol ® TMN-6 | Non-ionic | 0.9 | 0.9 | 0.9 | 0.9 |
| | surfactant | | | | |
| Capstone ™ FS-35 | Non-ionic | 0.65 | 0.65 | 0.65 | 0.65 |
| | fluoro- | | | | |
| | surfactant | | | | |
| Trisodium salt of | Chelating | 0.04 | 0.04 | 0.04 | 0.04 |
| methylglycinediacetic | agent | | | | |
| acid (Na₃MGDA) | | | | | |
| (Trilon ® M) | | | | | |
| 20 wt % 1,2- | Micro- | 0.2 | 0.2 | 0.2 | 0.2 |
| Benzisothiazolin- | biocide | | | | |
| 3-one | | | | | |
| (Acticide ® B20) | | | | | |
| Polyethylene emulsion | Wax | 0.8 | 0.8 | 0.8 | 0.8 |
| (Liquilube ™ 405 wax) | | | | | |
| Copolymer of styrene, | Acrylic | 7 | 7 | 7 | 7 |
| methyl methacrylate, | latex | | | | |
| butyl acrylate and | Particles | | | | |
| methacrylic acid | | | | | |
| Deionized water | Solvent | Balance | Balance | Balance | Balance |

Crodafos ™ is available from Croda ® International Plc, (England).
Tergitol ® is available from Union Carbide Corp. (New York).
Capstone ™ is available from DuPont ™ Chemicals and Fluoroproducts, (Delaware).
Trilon ® is available from BASF Corp. (Germany).
Acticide ® is available from Thor Specialties, Inc. (Connecticut).
Liquilube ™ is available from The Lubrizol Corp. (Ohio).

### Example 2

### Preparation of Fixer Fluid

A fixer fluid including a cationic fixing agent including an azetidinium-containing polyamine was prepared according to Table 2, as follows:

TABLE 2

| Component | Category | Amount (Wt %) |
|---|---|---|
| Tetraethylene Glycol | Organic | 12 |
| | Cosolvent | |
| Polycup ™ 7360A | Azetidinium- | 4 |
| | containing polyamine | |
| | Fixing Agent | |
| Surfynol ® 440 | Surfactant | 0.3 |
| Water | Solvent | Balance |

| | |
|---|---|
| Surface Tension | 30-33 cP |

Polycup ™ is available from Solenis LLC (Delaware).
Surfynol ® is available from Evonik, (Germany).

### Example 3

### Washfastness Durability

The ink compositions from Example 1 (20 grams per square meter (gsm)) with and without the fixer fluid from Example 2 (10 gsm) were jetted onto gray cotton and polyester/cotton blend fabric print media. Samples were cured at 150° C. for 3 minutes. Printed samples were washed 5 times with a conventional washer at 40° C. with detergent and air drying between each wash. Each sample was measured for OD and Lab before and after the 5 washes. After the five cycles, optical density (OD) and L*a*b* values were measured for comparison, and delta E (ΔE) values were calculated using the 1976 standard denoted as ΔE_{CIE} as well as the 2000 standard denoted as ΔE₂₀₀₀. Results are depicted in Tables 3A and 3B, as follows:

TABLE 3A
Gray Cotton Print Media

| | | OD | OD | | | |
|---|---|---|---|---|---|---|
| Ink | Fixer | (Pre- | (5 | | | |
| (20 gsm) | (10 gsm) | wash) | washes) | %ΔOD | ΔE_{CIE} | ΔE₂₀₀₀ |
| Table 1A | Yes | 1.106 | 1.088 | −1.6 | 1.06 | 0.95 |
| (K) | | | | | | |
| Table 1A | Yes | 1.117 | 1.103 | −1.2 | 0.71 | 0.35 |
| (C) | | | | | | |
| Table 1A | Yes | 1.020 | 0.988 | −3.1 | 2.61 | 1.20 |
| (M) | | | | | | |
| Table 1A | Yes | 1.078 | 1.061 | −1.6 | 1.98 | 0.63 |
| (Y) | | | | | | |
| Table 1B | Yes | 1.183 | 1.170 | −1.1 | 0.92 | 0.77 |
| (K) | | | | | | |
| Table 1B | Yes | 1.139 | 1.113 | −2.3 | 2.58 | 1.03 |
| (M) | | | | | | |
| Table 1A | No | 0.958 | 0.802 | −16.2 | 6.11 | 5.58 |
| (K) | | | | | | |
| Table 1A | No | 0.875 | 0.764 | −12.7 | 5.48 | 3.51 |
| (C) | | | | | | |
| Table 1A | No | 0.876 | 0.746 | −14.8 | 7.62 | 4.17 |
| (M) | | | | | | |
| Table 1A | No | 0.811 | 0.709 | −12.6 | 6.76 | 1.73 |
| (Y) | | | | | | |
| Table 1B | No | 0.950 | 0.783 | −17.5 | 6.99 | 4.54 |
| (K) | | | | | | |
| Table 1B | No | 0.943 | 0.750 | −20.5 | 11.54 | 6.21 |
| (M) | | | | | | |

TABLE 3B
65:35 Polyester/Cotton Blend

| | | OD | OD | | | |
|---|---|---|---|---|---|---|
| Ink | Fixer | (Pre- | (5 | | | |
| (3 dpp) | (1.5 dpp) | wash) | washes) | %ΔOD | ΔE_{CIE} | ΔE₂₀₀₀ |
| Table 1A | Yes | 1.148 | 1.123 | −2.2 | 0.71 | 0.60 |
| (K) | | | | | | |
| Table 1A | Yes | 1.138 | 1.138 | 0.0 | 0.55 | 0.23 |
| (C) | | | | | | |
| Table 1A | Yes | 1.096 | 1.083 | −1.1 | 1.53 | 0.74 |
| (M) | | | | | | |
| Table 1A | Yes | 1.058 | 1.064 | 0.6 | 1.29 | 0.49 |
| (Y) | | | | | | |
| Table 1B | Yes | 1.246 | 1.205 | −3.3 | 1.00 | 0.8 |
| (K) | | | | | | |
| Table 1B | Yes | 1.157 | 1.149 | −0.6 | 1.10 | 0.46 |
| (M) | | | | | | |
| Table 1A | No | 0.968 | 0.827 | −14.6 | 6.78 | 6.19 |
| (K) | | | | | | |
| Table 1A | No | 0.905 | 0.767 | −15.2 | 5.03 | 3.55 |
| (C) | | | | | | |
| Table 1A | No | 0.900 | 0.756 | −16.0 | 7.32 | 4.27 |
| (M) | | | | | | |
| Table 1A | No | 0.817 | 0.690 | −15.5 | 8.12 | 2.13 |
| (Y) | | | | | | |
| Table 1B | No | 0.960 | 0.811 | −15.6 | 7.01 | 4.89 |
| (K) | | | | | | |
| Table 1B | No | 0.979 | 0.826 | −15.6 | 8.10 | 4.42 |
| (M) | | | | | | |

As can be seen in the data presented in Tables 3A-3B, acceptable washfastness for individual ink compositions printed in combination with fixer fluid was verified by comparing pre-wash optical density (OD) with post-wash OD and ΔE_{CIE} or ΔE₂₀₀₀ calculated from pre- and post-wash L*a*b* values. This was true for black as well as all three colors (CMY) on both types of fabric print media evaluated. Thus, the combination of the inks of Example 1 (KCMY) printed with a fixer fluid as described in Example 2 has been shown to be a versatile fluid set and printing system. On the other hand, as also shown in Tables 3A-3B, the same inks printed without the fixer fluid did not have nearly the same level of washfastness.

### Example 4

### Comparative Washfastness Study

A comparative fixer composition was prepared in accordance with Table 4A below. Notably, the fixing agent was a cationic fixing agent without azetidinium groups.

TABLE 4A
Comparative Fixer Composition

| Component | Category | Wt % |
|---|---|---|
| Floquat ™ FL2350 | Fixing Agent | 2.45 |
| 2-pyrrolidone | Organic | 16 |
| | Cosolvent | |
| MPDiol (2-methyl-1,3- | Organic | 9 |
| propanediol) | Cosolvent | |
| Tergitol ® 15-S-7 | Surfactant | 0.95 |
| Capstone ® FS-35 | Surfactant | 0.41 |
| Water | Solvent | Balance |

Floquat ™ is available from SNF Ltd. (United Kingdom).

The K, C, and M ink compositions from Table 1B of Example 1 were jetted with and without the fixer fluid from Table 4A onto white 100% cotton fabric print media.

Samples were cured at 150° C. for 3 minutes. Printed samples were washed 5 times with a conventional washer at 40° C. with detergent and air drying between each wash. Each sample was measured for OD and Lab before and after the 5 washes. After the five cycles, optical density (OD) and L*a*b* values were measured for comparison, and delta E (ΔE) values were calculated using the 1976 standard denoted as ΔE_{CIE} as well as the 2000 standard denoted as ΔE2000. Results are depicted in Table 4B, as follows:

TABLE 4B
100% Cotton Print Medium

| | | OD | OD | | | |
|---|---|---|---|---|---|---|
| Ink | Fixer | (Pre- | (5 | | | |
| (3 dpp) | (1.5 dpp) | wash) | washes) | %ΔOD | ΔE_{CIE} | ΔE₂₀₀₀ |
| Table 1B | No | 1.11 | 0.98 | −11.8 | 4.62 | 3.95 |
| (K) | | | | | | |
| Table 1B | No | 1.06 | 0.96 | −9.5 | 2.98 | 1.67 |
| (C) | | | | | | |
| Table 1B | No | 1.06 | 0.97 | −9.8 | 5.77 | 2.37 |
| (M) | | | | | | |
| Table 1B | Yes | 1.13 | 0.94 | −17.0 | 8.62 | 7.37 |
| (K) | | | | | | |
| Table 1B | Yes | 1.08 | 0.91 | −16.1 | 8.60 | 5.98 |
| (C) | | | | | | |
| Table 1B | Yes | 1.06 | 0.88 | −16.6 | 10.24 | 5.20 |
| (M) | | | | | | |

As can be seen from the data in Table 4B, cationic fixing agent without azetidinium groups was inferior with respect to washfastness compared to when the cationic fixing agent included azetidinium groups, as determined by comparing pre-wash optical density (OD) with post-wash OD and ΔE_{CIE} or ΔE₂₀₀₀ calculated from pre- and post-wash L*a*b* values.

While the present technology has been described with reference to certain examples, various modifications, changes, omissions, and substitutions can be made without departing from the spirit of the disclosure. It is intended, therefore, that the disclosure be limited only by the scope of the following claims.

What is claimed is:

1. A fluid set, comprising:
an ink composition including:
an ink vehicle,
pigment, and
from 2 wt % to 15 wt % acrylic latex binder; and
a fixer fluid including:
a fixer vehicle, and
from 0.5 wt % to 12 wt % of a cationic fixing agent comprising an azetidinium-containing polyamine.

2. The fluid set of claim 1, wherein the pigment includes a black pigment, a cyan pigment, a magenta pigment, a yellow pigment, or a white pigment. 3 The fluid set of claim 1, wherein the acrylic latex binder is present in the ink composition at from 6 wt % to 11 wt %.

4. The fluid set of claim 1, wherein the azetidinium-containing polyamine has a ratio of crosslinked or uncrosslinked azetidinium groups to amine groups of from 0.1:1 to 10:1.

5. The fluid set of claim 1, wherein the fixer fluid is colorless.

6. The fluid set of claim 1, wherein the fixer vehicle comprises water and an organic co-solvent, the water being present in the fixer composition in an amount from 65 wt % to 96 wt % and the organic co-solvent being present in the fixer composition in an amount from 1.5 wt % to 34.5 wt %.

7. A printing system, comprising:
a print media substrate;
an ink composition including:
an ink vehicle,
pigment, and
from 2 wt % to 15 wt % acrylic latex binder; and
a fixer fluid including:
a fixer vehicle, and
from 0.5 wt % to 12 wt % of a cationic fixing agent comprising an azetidinium-containing polyamine.

8. The textile printing system of claim 7, wherein the print media substrate is a fabric substrate selected from cotton, polyester, nylon, silk, or a blend thereof.

9. The textile printing system of claim 7, wherein the azetidinium-containing polyamine comprises from 2 to 12 carbon atoms between individual amine groups.

10. A method of printing, comprising:
jetting a fixer fluid onto a print media substrate, wherein the fixer fluid includes a fixer vehicle and from 0.5 wt % to 12 wt % of a cationic fixing agent comprising an azetidinium-containing polyamine; and
jetting an ink composition onto the print media substrate in contact with the fixer fluid, wherein the ink composition includes an ink vehicle, pigment, and from 4 wt % to 15 wt % acrylic latex binder.

11. The method of claim 10, wherein jetting the fixer fluid and jetting the ink composition are performed simultaneously.

12. The method of claim 10, wherein the cationic fixing agent and the acrylic latex are jetted onto the print media substrate at a weight ratio from 0.01:1 to 1:1.

13. The method of claim 10, wherein jetting is from a thermal inkjet printhead.

14. The method of claim 10, wherein the fixer fluid has a surface tension of from 21 dyne/cm to 55 dyne/cm at 25° C. and a viscosity of from 1.5 cP to 15 cP at 25° C.

15. The method of claim 14, further comprising heating the fabric substrate having the fixer fluid and the ink composition jetted thereon to a temperature of from 80° C. to 200° C. for a period of from 5 seconds to 10 minutes.
